(19) United States
(12) Patent Application Publication
(10) Pub. No.: US 2011/0262219 A1
(43) Pub. Date: Oct. 27, 2011

(54) ROD CONNECTOR FOR CONNECTING THREADED RODS

(75) Inventor: Jan VAN WALRAVEN, Mijdrecht (NL)

(73) Assignee: J. VAN WALRAVEN HOLDING B.V., Mijdrecht (NL)

(21) Appl. No.: 12/764,594

(22) Filed: Apr. 21, 2010

(30) Foreign Application Priority Data
Apr. 21, 2010 (NL) 2002774

(51) Int. Cl. F16B 7/18; B21D 43/28

(52) U.S. Cl. 403/341; 72/324

(57) ABSTRACT

A rod connector for connecting threaded rods is adapted for holding in engagement two or more threaded rod sections. The rod sections are engaging with their threads in an overlapping area. The rod connector comprises a bracket with a plurality of flanges. At least one flange is provided with a retaining opening such that two or more threaded rods with their threads in mutual engagement fit in the retaining opening and are prevented from becoming disengaged. The bracket furthermore includes at least one connection portion interconnecting the flanges.

### BACKGROUND OF THE INVENTION

The present invention relates to a rod connector for connecting threaded rods. Such a rod connector is known.

In U.S. Pat. No. 4,671,698 is disclosed a sleeve for interconnecting rods provided with threads. The sleeve consists of a housing with a relatively smooth inside surface. In use the rods are brought with their threads into engament with each other, after which the sleeve is slided over the overlapping area of the two rods. The inside dimensions of the sleeve are such that it makes separation of the two rods in the overlapping area impossible.

The present invention has for an object to provide an alternative rod connector for connecting threaded rods.

### SUMMARY OF THE INVENTION

According to the invention this object is achieved by a rod connector for connecting threaded rods, which rod connector is adapted for holding in engagement two or more threaded rod sections which are engaging with their threads in an overlapping area. The rod connector comprises a bracket with a plurality of flanges, wherein at least one flange is provided with a retaining opening such that two or more threaded rods with their threads in mutual engagement fit in the retaining opening and are prevented from becoming disengaged, and the bracket including at least one connection portion interconnecting the flanges.

The rod connector according to the invention is relatively easy to manufacture compared to the rod connector known from the prior art. Furthermore, the rod connector according to the invention allows for an easy visual inspection of the connection between the threaded rods. In practise it is important that the overlapping area in which the threads of the rods engage each other is of sufficient length so as to be able to withstand pulling loads on the connection, e.g. due to loads suspending from one of the rods.

In a preferred embodiment one of the flanges of the bracket is an end flange, said end flange being provided with an opening for passing through a first rod and said end flange including at least one stop surface adjacent said round opening for abutting an end face of at least one second rod, wherein the bracket is substantially S-shaped with the end flange at an upper end and two flanges with retaining openings below it.

The invention furthermore relates to a method for manufacturing a rod connector for connecting threaded rods. In said method a metal strip is provided. Next, a round hole and at a distance therefrom at least two spaced apart elongate holes are punched out in the strip material. Finally, the strip is bended such that the two elongate holes are aligned and the round hole is aligned with one side of the elongate holes.

The invention will be elucidated in the following description of a preferred embodiment with reference to the drawings.

### BRIEF DESCRIPTION OF THE DRAWINGS

FIG. 1 shows a bracket of a preferred embodiment of a rod connector according to the invention; and

FIGS. 2-6 illustrate the use of the rod connector of FIG. 1.

### DESCRIPTION OF A PREFERRED EMBODIMENT

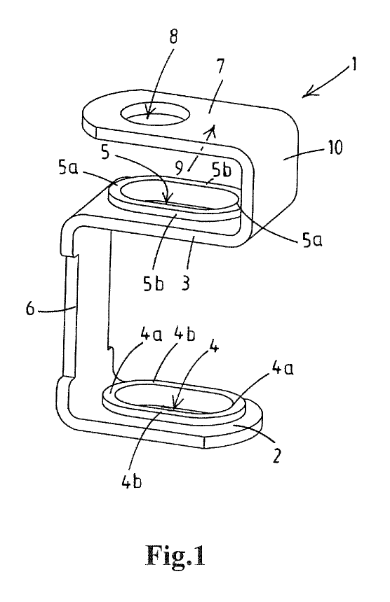

FIG. 1 shows a bracket 1 of a rod connector according to the invention. The bracket 1 has a first flange 2 and a second flange 3 which are substantially parallel to each other. The first flange is provided with an elongate hole 4. The second flange is provided with an elongate hole 5. The elongate holes 4 and 5 are aligned with each other. The holes 4 and 5 have essentially an oval shape with preferably, as shown in the drawing, an edge with two opposing half circle shaped edge portions 4a, 5a and two opposing straight edge portions 4b, 5b connecting the half circle edge portions 4a, 5a.

It is noted that the shape of the holes 4 and 5 as is shown in the drawing is not essential and could well be replaced by another shape as long as the contour of two threaded rods which are in overlapping engagement with each other narrowly fits through the elongate holes. Another essentially oval shape may thus be applied. It is also contemplated that instead of two, more than two threaded rods which are in engagement with each other can be retained together. This can be done by providing for example a substantial triangular shape or by an elongate slot shape in which three threaded holes in a side-by-side relation fit.

The first flange 2 and the second flange 3 are interconnected by a connection portion 6 of the bracket 1.

The bracket 1 furthermore comprises an end flange 7 which is substantially parallel to the first and second flanges 2 and 3. The end flange 7 is interconnected with the second flange 3 by means of a second connection portion 10 of the bracket 1. The bracket 1 thereby is generally S-shaped. The end flange 7 is provided with a hole 8 which forms a passage for a threaded rod. In the preferred embodiment the hole 8 is circular and has substantially the same radius as the radius of curvature of the curved edge portions 4a, 5a of the elongate holes 4 and 5. The hole 8 is aligned with one half of the elongate holes 4, 5 in the sense that the central axis of the hole 8 is in line with the centre of curvature of one of the curved edges 4a, 5a of the elongate holes 4 and 5.

The end flange 7 has a stop surface 9 on the side of the end flange 7 that faces the second flange 3. The stop surface 9 is located adjacent the hole 8 in line with one half of the elongate holes 4, 5.

The bracket 1 is preferably made of a metal strip material, which may be of steel. The bracket is manufactured by cutting a piece of strip material to a suitable length. Next, the elongate retaining holes 4 and 5, and the hole 8 are punched out of the strip material. Finally, the strip may be bended such that the flanges 2, 3 and 7 are parallel and the holes 4, 5 and 8 are aligned as is described in the above.

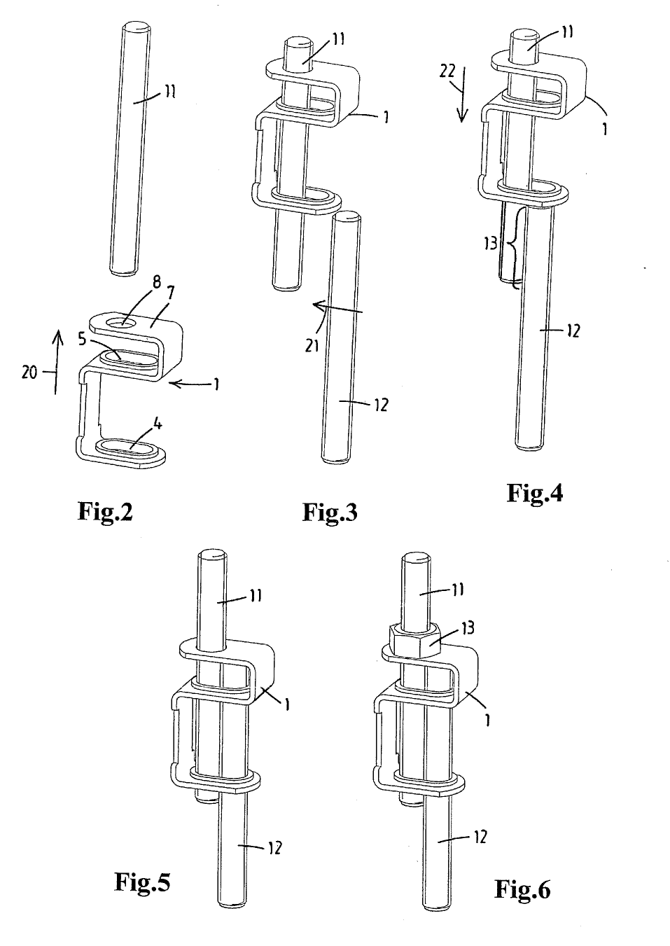

With reference to FIGS. 2-6 the use of the rod connector will be described.

In FIG. 2 is shown a suspended threaded rod 11 which at an upper end may be suspended from a ceiling, e.g. by connecting it to a rail mounted on the ceiling. The bracket 1 is slided from the lower end of the suspended rod 11 upwards, as is indicated by arrow 20, such that the rod is passed through the hole 8 in the end flange 7 and through the elongate holes 4 and 5 as is illustrated in FIG. 3.

In FIG. 3 is indicated by arrow 21 how a lower rod 12 is moved sideways towards the suspending rod 11 such that the threads of both rods 11, 12 are brought into engagement in an overlapping area 13, which is shown in FIG. 4.

In FIG. 4 is indicated by an arrow 22 how the bracket 1 is moved downwards along the suspended rod 11, such that the overlapping area 13 of the two rods 11, 12 is inserted through the elongate holes 4 and 5. The bracket 1 is moved downwards until the stop surface 9 on the end flange 7 abuts the end face of the lower rod 12. This state is shown in FIG. 5. The downward movement of the bracket 1 is thus limited by the upper end of the lower rod 12. The rods 11, 12 are retained in engagement with each other in the overlapping area 13 by the elongate holes 4 and 5.

Next, a nut 13, which was already present on the suspended rod 11 before the bracket was moved upwards on the suspended rod 11, can be screwed downwards such that it engages an upper surface of the end flange 7 surrounding the hole 8. The bracket 1 is now locked in position by the nut 13 since the end flange 7 is retained between the upper end of the lower rod 12 and the nut 13.

What is claimed is:

1. A rod connector for connecting threaded rods, which rod connector is adapted for holding in engagement two or more threaded rods which are engaging with their threads in an overlapping area, said rod connector comprising a bracket with a plurality of flanges, said bracket being substantially S-shaped with an end flange at an upper end and two flanges with retaining openings below it, which flanges are interconnected by respective connection portions, said retaining openings being shaped such that two or more threaded rods with their threads in mutual engagement fit in the retaining openings and are prevented from becoming disengaged, and said end flange being provided with an opening for passing through a first threaded rod and said end flange including at least one stop surface adjacent said round opening for abutting an end face of at least one second threaded rod.

2. The rod connector according to claim 1, wherein the bracket comprises parallel flanges.

3. The rod connector according to claim 1, wherein the bracket comprises three parallel flanges.

4. The rod connector according to claim 1, wherein the rod connector includes a nut which, in a mounted state, engages the end flange.

5. The rod connector according to claim 1, wherein the retaining opening in the flange(s) is of an elongate shape such that two threaded rods with their threads in mutual engagement fit in the retaining opening and are prevented from becoming disengaged.

6. The rod connector according to claim 1, wherein the bracket is made of (metal) strip material.

7. A method for manufacturing a rod connector for connecting threaded rods, wherein
a metal strip is provided,
a round hole and at a distance therefrom at least two spaced apart elongate holes are punched out in the strip material,
the strip is bended such that the two elongate holes are aligned and the round hole is aligned with one side of the elongate holes.
